(19) United States
(12) Patent Application Publication
(10) Pub. No.: US 2006/0066766 A1
(43) Pub. Date: Mar. 30, 2006

(54) Liquid crystal device and electronic apparatus

(76) Inventors: Chihiro Tanaka, Matsumoto (JP); Masahiro Horiguchi, Matsumoto (JP)

Correspondence Address: HARNESS, DICKEY & PIERCE, P.L.C., P.O. BOX 828, BLOOMFIELD HILLS, MI, 48303, US

(21) Appl. No.: 11/233,267

(22) Filed: Sep. 22, 2005

(30) Foreign Application Priority Data
Sep. 29, 2004 (JP) 2004-284094
Jul. 14, 2005 (JP) 2005-205481

(51) Int. Cl. G02F 1/136

(52) U.S. Cl. 349/44

(57) ABSTRACT

A liquid crystal device includes a first substrate; a second substrate that is bonded to the first substrate with pillar-shaped spacers interposed therebetween; and a liquid crystal layer that is provided between the first substrate and the second substrate. The first substrate includes pixel electrodes each having a plurality of unit electrode portions and connecting portions that connect the unit electrode portions; switching elements that are connected to the pixel electrodes; and wiring lines that are arranged between adjacent pixel electrodes to be connected to the switching elements. In the liquid crystal device, each wiring line includes a light shielding portion having a size larger than that of the spacer between the connecting portion of one pixel electrode and another pixel electrode positioned in the vicinity of the connecting portion, and the spacer is arranged to overlap the light shielding portion.

### BACKGROUND

1. Technical Field

The present invention relates to a liquid crystal device of a vertical alignment type suitable for displaying various information items.

2. Related Art

In general, active matrix liquid crystal display devices have a structure in which data lines, switching elements, such as TFDs (thin film diodes), and pixel electrodes are formed on one of two substrates opposite to each other, scanning lines, etc., are formed on the other substrate, and liquid crystal is injected between the two substrates. For example, this type of liquid crystal display device is disclosed in JP-A-2002-328627.

Further, in the liquid crystal display device, pillar-shaped spacers (hereinafter, referred to as ‘photo spacers’) are provided between the two substrates to maintain a uniform gap. Liquid crystal display devices having a normally white mode have a problem in that alignment disorder of liquid crystal molecules occurs around the photo spacers, which causes the leakage of light, resulting in a reduction in contrast. Therefore, in the liquid crystal display devices having the normally white mode, for example, a light shielding film, such as black matrix, is usually arranged at the positions of the photo spacers. Further, in general, each photo spacer is arranged at a position corresponding to the switching element.

### SUMMARY

An advantage of some aspects of the invention is that it provides a vertical-alignment-type liquid crystal device capable of preventing the leakage of light around photo spacers and of preventing the generation of defects in display, such as a reduction in contrast.

According to an aspect of the invention, a liquid crystal device includes a first substrate; a second substrate that is bonded to the first substrate with pillar-shaped spacers interposed therebetween; and a liquid crystal layer that is provided between the first substrate and the second substrate. The first substrate includes pixel electrodes each having a plurality of unit electrode portions and connecting portions that connect the unit electrode portions; switching elements that are connected to the pixel electrodes; and wiring lines that are arranged between adjacent pixel electrodes to be connected to the switching elements. In the liquid crystal device, each wiring line includes a light shielding portion having a size larger than that of the spacer between the connecting portion of one pixel electrode and another pixel electrode positioned in the vicinity of the connecting portion, and the spacer is arranged to overlap the light shielding portion.

In the above-mentioned liquid crystal device, the first substrate and the second substrate are bonded to each other with the pillar-shaped spacers interposed therebetween, and the liquid crystal layer is provided between the first substrate and the second substrate. The liquid crystal device is of a vertical alignment type, and the spacers are formed by, for example, a photolithography technique. The first substrate of the liquid crystal device includes the pixel electrodes, the switching elements, such as TFDs, connected thereto, and the wiring lines connected thereto. Therefore, the pixel electrodes are electrically connected to the wiring lines through the switching elements. The wiring line is formed between one pixel electrode and another pixel electrode adjacent thereto. Each pixel electrode includes a plurality of unit electrode portions and connecting portions for connecting the unit electrode portions.

In general, in the vertical-alignment-type liquid crystal device, the liquid crystal molecules are vertically aligned with respect to the first and second substrates in an initial alignment state. The alignment disorder of the liquid crystal molecules occurs around the spacers, which causes the leakage of light.

Therefore, in the above-mentioned liquid crystal device, the wiring line includes a light shielding portion having a size larger than that of the spacer between the connecting portion of one pixel electrode and another pixel electrode positioned in the vicinity of the connecting portion. That is, when the spacer overlaps the light shielding portion, the size of the light shielding portion is larger than that of the spacer in the overlapping portion in plan view. Preferably, a distance between a side of the light shielding portion and a side of the spacer corresponding thereto can be set to be equal to or larger than 1 μm. In addition, the light shielding portions can be formed of chrome, and the light shielding portion can be formed between the connecting portion of one pixel electrode and the pixel electrode of another pixel electrode positioned in the vicinity of the connecting portion.

In this liquid crystal device, the spacers are arranged to overlap the light shielding portions. Therefore, it is possible to prevent, that is, shield the leakage of light around the spacers, which makes it possible to prevent a reduction in contrast, and thus to obtain a high-quality display image without color irregularity.

Preferably, the unit electrode portion and the light shielding portion can be formed in a shape in which a distance between the outer circumference and the center thereof is equal. For example, the unit electrode portion and the light shielding portion can be formed substantially in polygonal or circular shapes.

Further, preferably, the second substrate can be provided with openings or projections formed at positions corresponding to substantially the centers of the unit electrode portions. Therefore, the openings or projections formed at positions corresponding to substantially the centers of the unit electrode portions on the second substrate make it possible to control the alignment directions of the liquid crystal molecules that are vertically aligned in an initial alignment state. That is, when a voltage is applied between the first substrate and the second substrate, an electric field of the unit electrode portions is controlled by interaction between the openings or projections and the unit electrode portions having the above-mentioned shape, so that a region where the liquid crystal molecules are radially arranged is formed. As a result, the viewing angle dependence is lowered, which makes it possible to widen the viewing angle.

According to another aspect of the invention, a liquid crystal device includes a first substrate; a second substrate that is bonded to the first substrate with pillar-shaped spacers interposed therebetween; and a liquid crystal layer that is provided between the first substrate and the second substrate. The first substrate includes light shielding portions; wiring lines; switching elements that are connected to the wiring lines; an insulating film that has contact holes each formed at a position corresponding to a portion of the switching element and covers the light shielding portions, the wiring lines, and the switching elements; and pixel electrodes each of which includes a plurality of unit electrode portions and connecting portions for connecting the unit electrode portions, and which are formed on the insulating film to be connected to the switching elements through the contact holes. In the liquid crystal device, each light shielding portion has a size larger than that of the spacer, and is formed between the connecting portion of one pixel electrode and another pixel electrode adjacent thereto, and the spacer is arranged on the insulating film to overlap the light shielding portion.

In the above-mentioned liquid crystal device, the first substrate and the second substrate are bonded to each other with the pillar-shaped spacers interposed therebetween, and the liquid crystal layer is provided between the first substrate and the second substrate. The liquid crystal device is of a vertical alignment type, and the spacers are formed by, for example, a photolithography technique. The first substrate of the liquid crystal device includes the light shielding portions, the wiring lines, the switching elements, such as TFDs, connected thereto, the insulating film that has the contact holes therein and covers the light shielding portions, the wiring lines, and the switching elements, and the pixel electrodes formed on the insulating film.

Preferably, the light shielding portions can be formed of tantalum, chrome, or black resin, and can be formed between adjacent wiring lines. Each wiring line can be formed at a position overlapping the pixel electrode, for example, substantially at the center of the pixel electrode in the widthwise direction. Since the wiring lines and the light shielding portions are formed of the same material, they can be formed in the same process, which makes it possible to simplify a manufacturing process thereof.

Each pixel electrode includes a plurality of unit electrode portions and connecting portions for connecting the unit electrode portions. In addition, the pixel electrode is connected to the switching element through the contact hole. Further, the pixel electrode is electrically connected to the wiring line through the switching element. Thus, the first substrate has a so-called overlayer structure in which the pixel electrodes are insulated from the switching elements and the wiring lines by the insulating film.

In the above-mentioned liquid crystal device, the size of the light shielding portion is larger than that of the spacer in plan view, and the light shielding portion is formed between the connecting portion of one pixel electrode and another pixel electrode adjacent thereto. In addition, the spacers are arranged on the insulating film to overlap the light shielding portions. Preferably, a distance between a side of the light shielding portion and a side of the spacer corresponding thereto can be set to be equal to or larger than 1 μm. In this way, it is possible to prevent, that is, shield the leakage of light around the spacers, which makes it possible to prevent a reduction in contrast, and thus to obtain a high-quality display image without color irregularity.

Preferably, the unit electrode portion and the light shielding portion can be formed in a shape in which a distance between the outer circumference and the center thereof is equal. For example, the unit electrode portion and the light shielding portion can be formed substantially in polygonal or circular shapes.

Further, preferably, the second substrate can be provided with openings or projections formed at positions corresponding to substantially the centers of the unit electrode portions on the second substrate. Therefore, the openings or projections formed at positions corresponding to substantially the centers of the unit electrode portions make it possible to control the alignment directions of the liquid crystal molecules that are vertically aligned in an initial alignment state. That is, when a voltage is applied between the first substrate and the second substrate, an electric field of the unit electrode portions is controlled by interaction between the openings or projections and the unit electrode portions having the above-mentioned shape, so that a region where the liquid crystal molecules are radially arranged is formed. As a result, the viewing angle dependence is lowered, which makes it possible to widen the viewing angle.

According to still another aspect of the invention, a liquid crystal device includes a first substrate; a second substrate that is bonded to the first substrate with pillar-shaped spacers interposed therebetween; and a liquid crystal layer that is provided between the first substrate and the second substrate. The first substrate includes light shielding portions; wiring lines; switching elements that are connected to the wiring lines; an insulating film that has contact holes each formed at a position corresponding to a portion of the switching element and covers the light shielding portions, the wiring lines, and the switching elements; a reflective film that is formed in a portion of an pixel region on the insulating film; and pixel electrodes each of which includes a plurality of unit electrode portions, a first connecting portion for connecting the unit electrode portions, and a second connecting portion that extends from one outer side of the unit electrode portion to the contact hole to be connected to the switching element through the contact hole, and is formed on the reflective film and the insulating film. In the liquid crystal device, each light shielding portion has a size larger than that of the spacer, and is formed between the first connecting portion of one pixel electrode and another pixel electrode adjacent thereto, and the spacer is arranged on the insulating film to overlap the light shielding portion.

In the above-mentioned liquid crystal device, the first substrate and the second substrate are bonded to each other with the pillar-shaped spacers interposed therebetween, and the liquid crystal layer is provided between the first substrate and the second substrate. The liquid crystal device is of a vertical alignment type, and the spacers are formed by, for example, a photolithography technique. The first substrate of the liquid crystal device includes the light shielding portions, the wiring lines, the switching elements, such as TFDS, connected thereto, the insulating film that has the contact holes therein and covers the light shielding portions, the wiring lines, and the switching elements, the reflective film that is formed in a portion of each pixel region on the insulating film, and the pixel electrodes formed on the reflective film and the insulating film in the pixel electrode regions.

Preferably, the light shielding portions can be formed of tantalum, chrome, or black resin, and can be formed between adjacent wiring lines. Each wiring line can be formed at a position overlapping the pixel electrode, for example, substantially at the center of the pixel electrode in the widthwise direction. Since the wiring lines and the light shielding portions are formed of the same material, they can be formed in the same process, which makes it possible to simplify a manufacturing process thereof. The reflective film can be formed to correspond to one or more unit electrode portions.

Each pixel electrode includes a plurality of unit electrode portions, a first connecting portion for connecting the unit electrode portions, and a second connecting portion that extends from one outer side of the unit electrode portion to the contact hole to be connected to the switching element through the contact hole. Therefore, the pixel electrode is connected to the switching element through the contact hole. In addition, the pixel electrode is electrically connected to the wiring line through the switching element. Thus, the first substrate has a so-called overlayer structure in which the pixel electrodes are insulated from the switching elements and the wiring lines by the insulating film. Furthermore, in the liquid crystal device, the reflective film is formed in a portion of each pixel region, so that a transflective liquid crystal device is constituted. Thus, the liquid crystal device according to this aspect can perform both reflective display and transmissive display.

In the above-mentioned liquid crystal device, the size of the light shielding portion is larger than that of the spacer in plan view, and the light shielding portion is formed between the first connecting portion of one pixel electrode and the first connecting portion of another pixel electrode adjacent thereto. In addition, the spacers are arranged on the insulating film to overlap the light shielding portions. Preferably, a distance between a side of the light shielding portion and a side of the spacer corresponding thereto can be set to be equal to or larger than 1 μm. In this way, it is possible to prevent, that is, shield the leakage of light around the spacers, which makes it possible to prevent a reduction in contrast, and thus to obtain a high-quality display image without color irregularity.

Further, in the above-mentioned aspects, it is preferable that the second substrate include a colored layer that is formed at positions corresponding to the pixel regions; an insulating film that is formed with a predetermined thickness on the colored layer to correspond to at least the reflective film; and strip-shaped transparent electrodes that are formed on the colored layer and the insulating film.

According to the above-mentioned structure, in the second substrate, the strip-shaped transparent electrodes are formed on the colored layer, and the colored layer is formed to correspond to the pixel regions. Therefore, this structure makes it possible to perform color display. In addition, the insulating film is formed with a predetermined thickness on the colored layer so as to correspond to at least the reflective film. Therefore, the thicknesses of the liquid crystal layer are different from each other in the reflective display region having the reflective film formed therein and the transmissive display region not having the reflective film in the pixel region of the liquid crystal device. That is, the liquid crystal device has a multi-gap structure. In this way, the liquid crystal device can perform proper display in both transmissive display and reflective display.

Preferably, the unit electrode portions and the light shielding portions can be formed in a shape where a distance between the outer circumference and the center thereof is equal. For example, the unit electrode portion and the light shielding portion can be formed in substantially polygonal or circular shapes.

Further, preferably, the second substrate can be provided with openings or projections formed at positions corresponding to substantially the centers of the unit electrode portions. Therefore, the openings or projections formed at positions corresponding to substantially the centers of the unit electrode portions on the second substrate make it possible to control the alignment directions of the liquid crystal molecules that are vertically aligned in an initial alignment state. That is, when a voltage is applied between the first substrate and the second substrate, an electric field of the unit electrode portions is controlled by interaction between the openings or projections and the unit electrode portions having the above-mentioned shape, so that a region where the liquid crystal molecules are radially arranged is formed. As a result, the viewing angle dependence is lowered, which makes it possible to widen the viewing angle.

Furthermore, according to yet another aspect of the invention, an electronic apparatus includes the above-mentioned liquid crystal device as a display unit.

### BRIEF DESCRIPTION OF THE DRAWINGS

The invention will be described with reference to the accompanying drawings, wherein like numbers reference like elements.

FIG. 1 is a plan view illustrating the structure of electrodes and wiring lines of a liquid crystal display device according to a first embodiment of the invention.

FIG. 2 is a cross-sectional view illustrating the liquid crystal display device according to the first embodiment.

FIG. 3 is a plan view illustrating the structure of electrodes and wiring lines of an element substrate according to the first embodiment.

FIG. 4 is a plan view illustrating the structure of electrodes of a color filter substrate according to the first embodiment.

FIG. 5 is a plan view illustrating a structure for preventing the leakage of light around photo spacers according to the first embodiment.

FIG. 6 is a cross-sectional view illustrating the structure for preventing the leakage of light around the photo spacers according to the first embodiment.

FIG. 7 is a plan view illustrating a structure for preventing the leakage of light around photo spacers according to a second embodiment.

FIG. 8 is a cross-sectional view illustrating the structure of an overlayer of an element substrate according to the second embodiment.

FIG. 9 is a cross-sectional view illustrating the structure for preventing the leakage of light around the photo spacers according to the second embodiment.

FIG. 10 is a flow chart illustrating a method of manufacturing a liquid crystal display device according to the second embodiment.

FIG. 11 is a flow chart illustrating a method of manufacturing the element substrate according to the second embodiment.

FIGS. 12A to 12C are partial plan views corresponding to a manufacturing process of the element substrate according to the second embodiment.

FIGS. 13A and 13B are partial plan views corresponding to the manufacturing process of the element substrate according to the second embodiment.

FIG. 14 is a plan view illustrating a structure for preventing the leakage of light around photo spacers according to a third embodiment.

FIG. 15 is a cross-sectional view illustrating the structure of an element substrate according to a third embodiment.

FIG. 16 is a circuit block diagram illustrating an electronic apparatus to which the liquid crystal display device according to the invention is applied.

FIGS. 17A and 17B are perspective views illustrating examples of the electronic apparatus to which the liquid crystal display device according to the invention is applied.

### DESCRIPTION OF EXEMPLARY EMBODIMENTS

Hereinafter, preferred embodiments of the invention will be described with reference to the accompanying drawings. However, in the following embodiments, the invention is applied to a liquid crystal display device. In addition, photo spacers are arranged at positions apart from adjacent pixel electrodes, and light shielding portions are formed below the photo spacers. This structure makes it possible to prevent the leakage of light around the photo spacers and a reduction in contrast.

### First Embodiment

In a first embodiment, a portion of a data line is formed to have a large width, and the portion serves as the light shielding portion, thereby obtaining the above-mentioned effects.

Structure of Liquid Crystal Display Device

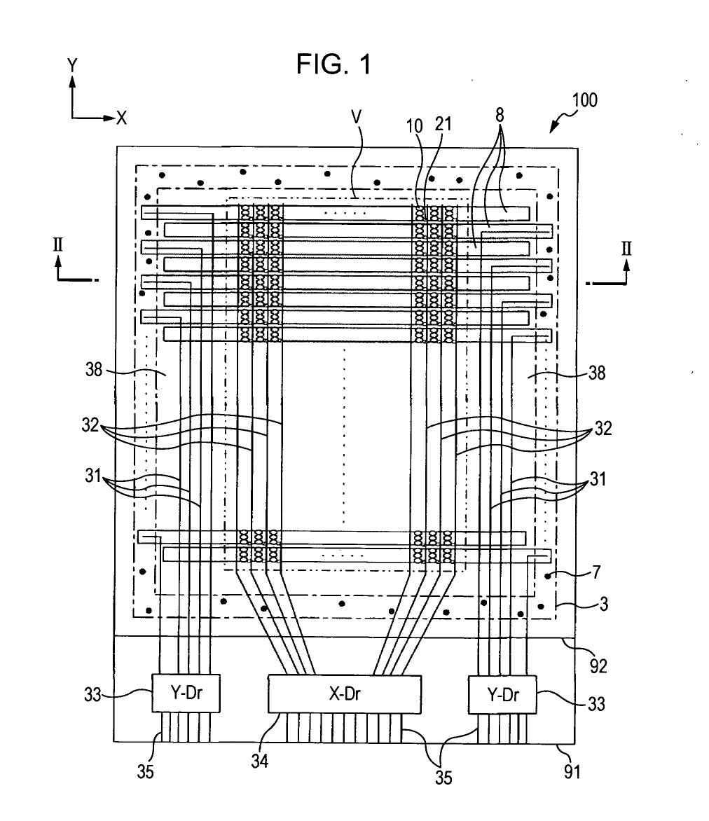

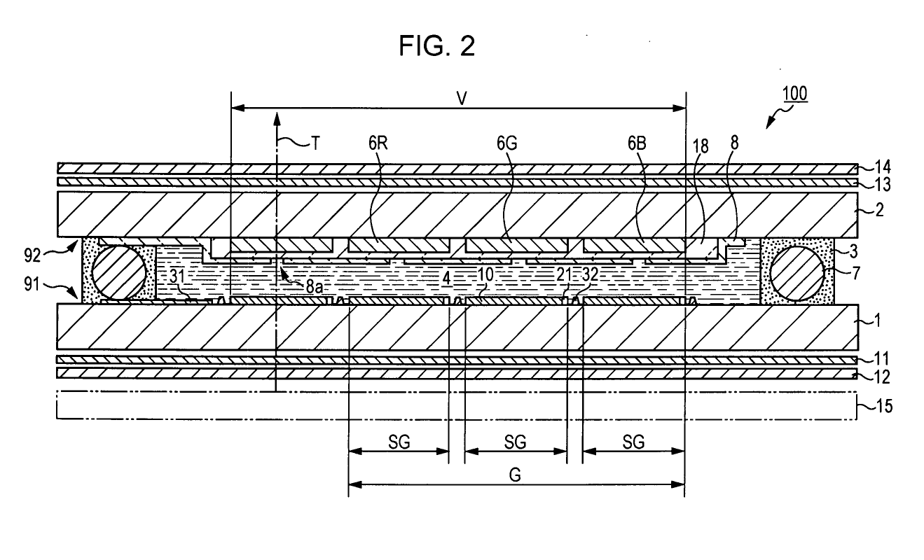

First, the structure of a liquid crystal display device according to the first embodiment of the invention will be described. FIG. 1 is a plan view schematically illustrating the structure of a liquid crystal display device 100 according to the invention. Specifically, FIG. 1 is a plan view showing the structure of electrodes and wiring lines of the liquid crystal display device 100 according to the invention. The liquid crystal display device 100 of the invention is a transmissive liquid crystal display device of an active matrix driving type using TFD elements. In addition, the liquid crystal display device 100 of the invention is a vertical-alignment-type liquid crystal display device having a normally black display mode. FIG. 2 is a cross-sectional view taken along the line II-II of the liquid crystal display device 100 shown in FIG. 1.

First, the sectional structure of the liquid crystal display device 100 taken along the line II-II will be described with reference to FIG. 2, and then the structure of the electrodes and the wiring lines of the liquid crystal display device 100 will be described.

In FIG. 2, in the liquid crystal display device 100, an element substrate 91 is bonded to a color filter substrate 92 arranged opposite to the element substrate 91 with a frame-shaped sealing member 3 interposed therebetween, and liquid crystal having negative dielectric anisotropy is injected therebetween to form a liquid crystal layer 4. The frame-shaped sealing member 3 contains a conductive member 7 composed of, for example, a plurality of metal particles.

A pixel electrode 10 and a TFD element 21 are formed in each sub-pixel region SG on an inner surface of a lower substrate 1. In addition, data lines 32 are formed between the pixel electrodes 10 on the inner surface of the lower substrate 1. Each pixel electrode 10 is electrically connected to the data line 32 through the TFD element 21. The data line 32 is preferably formed of a conductive material, such as chrome. In addition, pillar-shaped photo spacers 27 are formed at positions separated from adjacent pixel electrodes 10 (except for the vicinities of the TFT elements), although not shown in FIG. 2. Scanning lines 31 are formed at right and left edges of the inner surface of the lower substrate 1. One end of each of the scanning lines 31 extends into the sealing member 3, and the scanning lines 31 are electrically connected to the conductive member 7 in the sealing member. 3. A vertical alignment film (not shown) formed of, for example, polyimide is formed on the inner surfaces of the lower substrate 1, the pixel electrodes 10, the TFD elements 21, the data lines 32, and the scanning lines 31.

Meanwhile, R, G, and B colored layers 6R, 6G, and 6B are formed in sub-pixel regions SG on an inner surface of an upper substrate 2. The colored layers 6R, 6G, and 6B constitute a color filter. A pixel G indicates a region corresponding to one color pixel composed of R, G, and B sub-pixels. In the following description, when the colored layer is indicated regardless of color, the colored layer is simply referred to as the ‘colored layer 6’. However, when the colors of the colored layers are distinguished from each other, the colored layer is specifically referred to as, for example, the ‘red colored layer 6R’. In addition, as described above, the liquid crystal display device 100 according to the first embodiment has a normally black display mode, and a black light shielding film BM is not formed between the colored layers 6. An overcoat layer 18 formed of, for example, transparent resin is formed on the inner surfaces of the upper substrate 2 and the colored layers 6. The overcoat layer 18 has a function of protecting the colored layers 6 from corrosion or contamination caused by a chemical used when the color filter substrate is manufactured. Strip-shaped transparent electrodes (scanning lines) 8 formed of, for example, ITO (indium tin oxide) are formed on an inner surface of the overcoat layer 18.

Each transparent electrode 8 has an opening 8a at a position corresponding to substantially the center of a unit electrode portion 10u constituting the pixel electrode 10, which will be described later. When a voltage is applied between the element substrate 91 and the color filter substrate 92, an electric field corresponding to the voltage is formed in the liquid crystal layer 4 between the two substrates such that each unit electrode portion 10u is formed in a polygonal shape. In addition, since the opening 8a is formed in the transparent electrode 8 on the color filter substrate 92 arranged opposite thereto, the alignment state of liquid crystal molecules is controlled such that the liquid crystal molecules are radially arranged with respect to the center of each unit electrode portion 10u. In this way, the viewing angle dependence of the liquid crystal display device 100 according to the first embodiment can be controlled, and the viewing angle thereof can be widened.

Further, one end of each of the transparent electrodes 8 extends into the sealing member 3 to be electrically connected to the conductive member 7 in the sealing member 3. A vertical alignment film (not shown) formed of, for example, polyimide is formed on the inner surfaces of the transparent electrodes 8.

Furthermore, a retardation plate (a quarter-wave plate) 11 and a polarizing plate 12 are arranged on an outer surface of the lower substrate 1, and a retardation plate (a quarter-wave plate) 13 and a polarizing plate 14 are arranged on an outer surface of the upper substrate 2. A backlight 15 is formed below the polarizing plate 12. The backlight 15 is preferably formed by a combination of a point light source, such as an LED (light emitting diode) or a line light source, such as a cold cathode fluorescent tube, and an optical waveguide.

The transparent electrodes 8 on the upper substrate 2, that is, the scanning lines on the upper substrate 2 are vertically connected to the scanning lines 31 on the lower substrate 1 through the conductive member 7 in the sealing member 3.

When transmissive display is performed in the liquid crystal display device 100 of the first embodiment, illumination light emitted from the backlight 15 travels along a path shown in FIG. 2, and then passes through the pixel electrodes 10 and the colored layers 6 to reach an observer. In this case, the illumination light passes through the colored layers 6 to have a predetermined color and brightness. In this way, the observer can view a predetermined color display image.

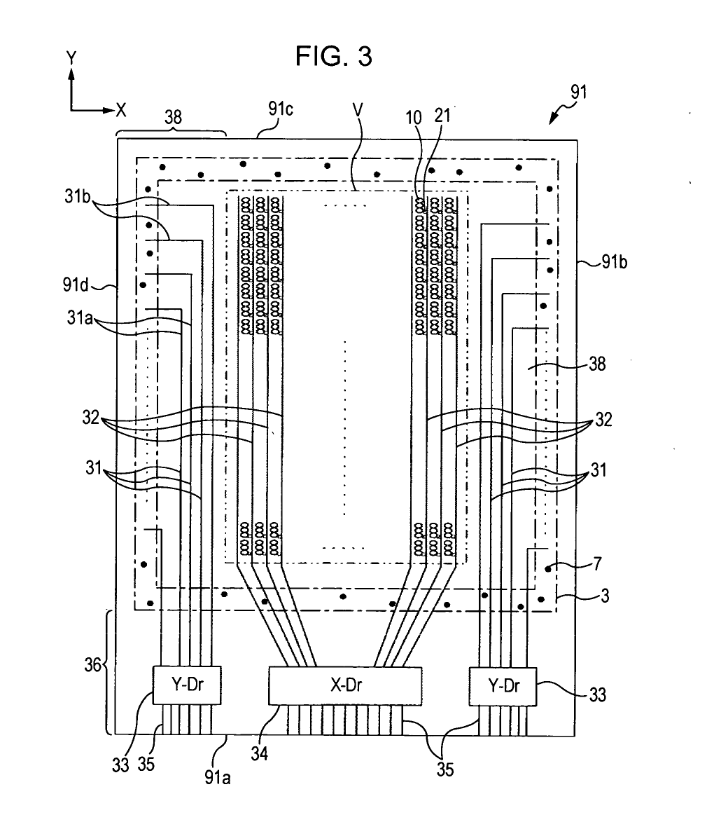

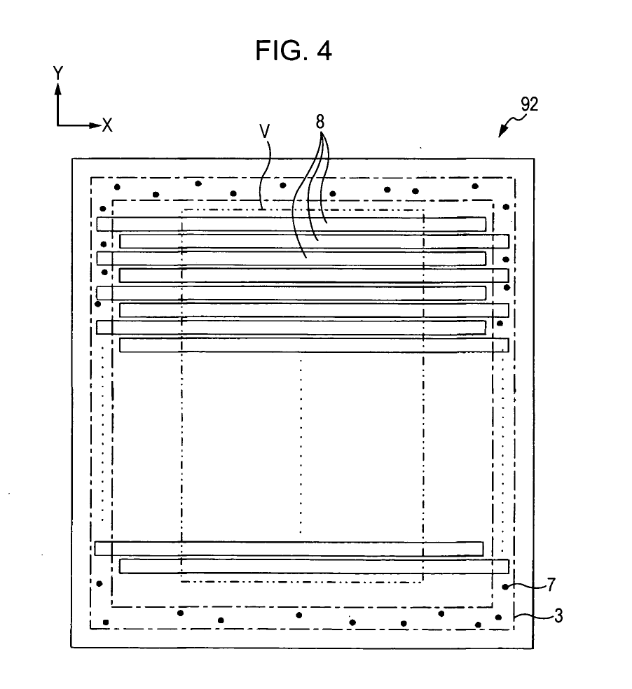

Next, the structure of the electrodes and the wiring lines of the element substrate 91 and the color filter substrate 92 according to the first embodiment will be described with reference to FIGS. 1, 3, and 4. FIG. 3 is a plan view illustrating the structure of the electrodes and the wiring lines of the element substrate 91 as viewed from the front side (that is, the upper side of the liquid crystal display device shown in FIG. 2) of the element substrate 91. FIG. 4 is a plan view illustrating the structure of the electrodes of the color filter substrate 92 as viewed from the front side (that is, the lower side of the liquid crystal display device shown in FIG. 2) of the color filter substrate 92. In addition, components other than the electrodes and the wiring lines are not shown in FIGS. 3 and 4 for the sake of the simplicity of explanation.

In FIG. 1, intersecting regions of the pixel electrodes 10 of the element substrate 91 and the transparent electrodes 8 of the color filter substrate 92 constitute sub-pixel regions SG, which are elemental display units. A region in which a plurality of sub-pixel regions SG are arranged in a matrix along the row and column directions in the plane is an effective display region V (a region surrounded by a two-dot chain line). For example, characters, numbers, and figures can be displayed on the effective display region V. In FIGS. 1 and 3, a region between the edge of the liquid crystal display device 100 and the effective display region V is a frame region 38 not contributing to image display.

Structure of Electrodes and Wiring Lines.

First, the structure of the electrodes and the wiring lines of the element substrate 91 will be described with reference to FIG. 3. The element substrate 91 includes the TFD elements 21, the pixel electrodes 10, a plurality of scanning lines 31, a plurality of data lines 32, Y driver ICs 33, an X driver IC 34, and a plurality of external connection terminals 35.

The Y driver ICs 33 and the X driver IC 34 are mounted on a protruding region 36 of the element substrate 91 with an ACF (anisotropic conductive film) interposed therebetween. In FIG. 3, a direction from one side 91a of the protruding region 36 of the element substrate 91 toward another side 91c opposite to the one side 91a is referred to as a Y direction, and a direction from a side 91d toward a side 91b is referred to as an x direction.

The plurality of external connection terminals 35 is formed on the protruding region 36. Input terminals (not shown) of the Y driver ICs 33 and the X driver IC 34 are connected to the plurality of external connection terminals 35 through conductive bumps. The external connection terminals 35 are connected to a wiring substrate (not shown), such as a flexible printed circuit board through the ACF or solder. In this way, signals or power is supplied from an electronic apparatus, such as a cellular phone or an information terminal, to the liquid crystal display device 100.

Output terminals (not shown) of the X driver IC 34 are connected to the plurality of data lines 32 through conductive bumps. Meanwhile, output terminals (not shown) of each Y driver IC 33 are connected to the plurality of scanning lines 31 through conductive bumps. In this way, each Y driver IC 33 outputs scanning signals to the plurality of scanning lines 31, and the X driver IC 34 outputs data signals to the plurality of data lines 32.

The plurality of data lines 32 are wiring lines extending substantially linearly in the longitudinal direction of FIG. 3, and are formed in the Y direction from the protruding region 36 toward the effective display region V. The data lines 32 are formed at predetermined intervals. In addition, the data lines 32 are connected to the TFD elements 21 at proper intervals, and each TFD element 21 is connected to the corresponding pixel electrode 10.

The plurality of scanning lines 31 are composed of main line portions 31a and bent line portions 31b that are bent substantially at a right angle with respect to the main line portions 31a. Each main line portion 31a is formed to extend from the protruding region 36 in the Y direction in the frame region 38. In addition, the main line portions 31a are formed substantially in parallel to the data lines 32 at predetermined intervals. Each bent line portion 31b extends in the X direction to reach the sealing member 3 in the frame region 38. Therefore, end parts of the bent line portions 31b are connected to the conductive member 7 contained in the sealing member 3.

Next, the structure of the electrodes of the color filter substrate 92 will be described. As shown in FIG. 4, the color filter substrate 92 is provided with the strip-shaped transparent electrodes (scanning lines) 8 extending in the Y direction. As shown in FIGS. 1 and 4, a left or right end of each transparent electrode 8 extends into the sealing member 3 to be connected to the conductive member 7 in the sealing member 3.

As described above, FIG. 1 shows a state in which the color filter substrate 92 is bonded to the element substrate 91 with the sealing member 3 interposed therebetween. As shown in FIG. 1, the transparent electrodes 8 of the color filter substrate 92 are orthogonal to the data lines 32 of the element substrate 91, and overlap the pixel electrodes 10 horizontally arranged in plan view. In this way, an overlapping region of the transparent electrode 8 and the pixel electrode 10 constitutes the sub-pixel region SG.

Further, the transparent electrodes 8 of the color filter substrate 92 (that is, the scanning lines of the color filter substrate 92) overlap the scanning lines 31 on the right and left sides of the element substrate 91, as shown in FIG. 1. In addition, the transparent electrodes 8 are vertically connected to the scanning lines 31 through the conductive member 7 in the sealing member 3. That is, the scanning lines, serving as the transparent electrodes 8, of the color filter substrate 92 are alternately connected to the scanning lines 31 of the element substrate 91 on the right side and the left side thereof, as shown in FIG. 1. In this way, the transparent electrodes 8 of the color filter substrate 92 are electrically connected to the Y driver ICs 33 arranged on the right and left sides of FIG. 1 through the scanning lines 31 of the element substrate 91.

Structure for Preventing Leakage of Light Around Photo Spacer

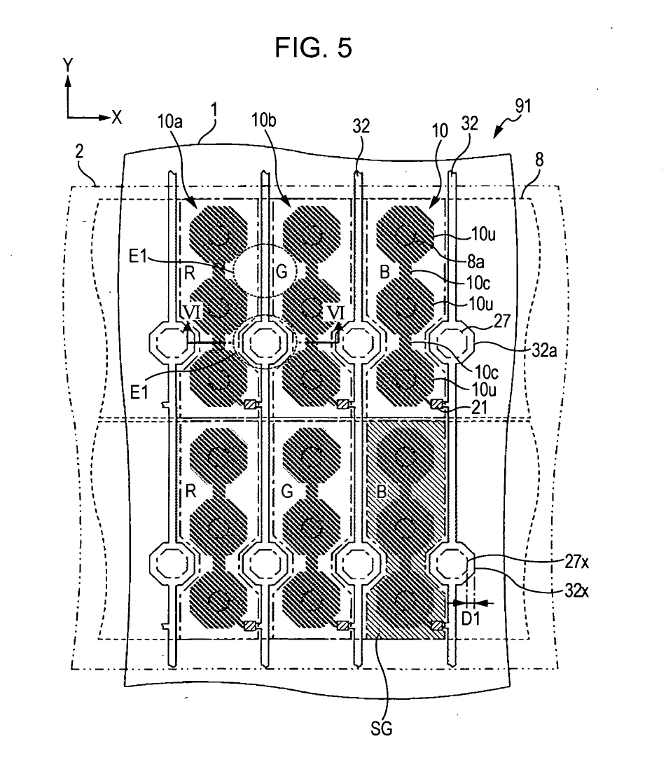

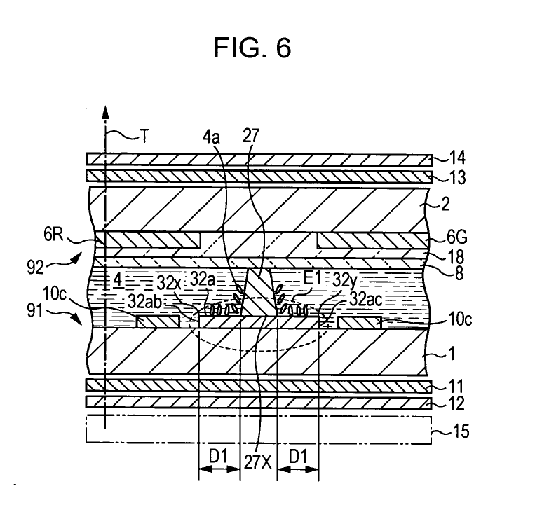

Next, the structure of the element substrate 91 for preventing (shielding) the leakage of light occurring around the photo spacer 27 according to the first embodiment of the invention will be described with reference to FIGS. 5 and 6. FIG. 5 is a partial plan view illustrating the layout of the pixel electrodes 10 of the element substrate 91. FIG. 6 is a partial cross-sectional view taken along the line VI-VI of FIG. 5. In FIG. 6, the element substrate 91 and the color filter substrate 92 are arranged in the same manner as those shown in FIG. 2.

As shown in FIG. 5, the pixel electrode 10 is formed in the sub-pixel region SG (a hatched portion) on the lower substrate 1. The pixel electrode 10 includes a plurality of polygonal transparent electrode portions (hereinafter, referred to as ‘unit electrode portions 10u’) and narrow connecting portions 10c for connecting the unit electrode portions 10u. The unit electrode potions 10u are arranged in the Y direction, and they have a shape in which three beads are skewered in the plan view of the pixel electrode 10.

Therefore, considering a pixel electrode 10a and a pixel electrode 10b adjacent thereto, a region E1 is formed between the connecting portion 10c for connecting the unit electrode potions 10u of the pixel electrode 10a and the connecting portion 10c for connecting the unit electrode portions 10u of the pixel electrode 10b adjacent to the connecting portion 10c of the pixel electrode 10a. Therefore, the region E1 is positioned between the sub-pixel regions SG corresponding to the pixel electrodes 10a and 10b. That is, the region E1 is formed at a position separated from the unit electrode portions 10u of the pixel electrodes 10a and 10b, and the photo spacer 27 is arranged in the region E1.

In the first embodiment, the photo spacer 27 is arranged in one of a plurality of regions E1 formed between the pixel electrodes 10a and 10b, that is, the region E1 in the vicinity of the TFD element 21. However, this structure is just an illustrative example, and thus another structure may be used in which the photo spacer 27 is arranged in one of the plurality of regions E1 formed between the pixel electrodes 10a and 10b which is separated from the TFD element 21.

Further, in the vertical alignment mode, each unit electrode portion 10u is preferably formed in a polygonal or circular shape in which all distances from the center to any point on the outer circumference thereof are substantially equal in order to make the liquid crystal molecules substantially radially arranged on the unit electrode portions 10u. Therefore, in the first embodiment, the unit electrode portion 10u is formed in a polygonal shape. The reason why a plurality of unit electrodes 10u is formed in one sub-pixel region SG is that, the smaller the size of the unit electrode portion 10u is, the easier the control of the alignment state of the liquid crystal molecules becomes. That is, this structure enables the alignment of the liquid crystal molecules to be more accurately controlled, compared with a case in which a large unit electrode portion constitutes one pixel electrode.

In FIG. 5, the pixel electrodes 10 are arranged in a matrix on the lower substrate 1, and a group of pixel electrodes 10 arranged in a line along the Y direction is connected to a common data line 32 through the TFD element 21. In addition, a plurality of pixel electrodes 10 arranged in a line along the X direction is disposed opposite to one transparent electrode 8 (scanning line) on the upper substrate 2. Openings 8a having circular shapes in plan view are formed in the transparent electrode 8 at positions corresponding to substantially the centers of the unit electrode portions 10u constituting the pixel electrode 10 (see FIG. 2). The openings 8a formed in the transparent electrodes 8 make it possible to control the alignment direction of the liquid crystal molecules that are vertically aligned in an initial alignment state. That is, when a voltage is applied between the element substrate 91 and the color filter substrate 92, an electric field of each unit electrode portion 10u is controlled by the interaction between the opening 8a and the unit electrode portion 10u, and thus a region in which the liquid crystal molecules are radially aligned is formed.

The data lines 32 are formed between the pixel electrodes 10 so as to extend in the Y direction. In particular, each data line 32 is formed to have a region (hereinafter, referred to as a ‘light shielding portion 32a’) where the width thereof is large in the region E1. In other words, paying attention to the pixel electrodes 10a and 10b, the data line 32 is formed to include a light shielding portion having a size larger than that of the photo spacer 27, in plan view, in the region E1 positioned between the connecting portion 10c of the pixel electrode 10a disposed around the TFD element 21 and the connecting portion 10c of the pixel electrode 10b disposed adjacent to the connecting portion 10c of the pixel electrode 10a. In addition, the light shielding portion 32a is formed substantially in a polygonal shape in plan view.

The photo spacer 27 is arranged on an inner surface of the light shielding portion 32a so as to overlap the light shielding portion 32a. In the first embodiment, the photo spacer 27 is not arranged to correspond to the TFD element 21. When the photo spacer 27 is arranged to correspond to TFD element 21, the light shielding portion 32a cannot be formed, which makes it difficult to obtain the effects of the invention.

Next, the main sectional structure around the light shielding portion 32a will be described with reference to FIG. 6. In the following description, the same components as described above have the same reference numerals, and a detailed description thereof will be omitted.

The light shielding portion 32a, which is a portion of the data line 32 having a large width, is formed on a portion of the inner surface of the lower substrate 1 corresponding to the region E1. The connecting portions 10c constituting the pixel electrodes 10a and 10b are respectively formed in the vicinities of right and left outer circumferential portions 32ab and 32ac of the light shielding portion 32 on the inner surface of the lower substrate 1. The photo spacer 27 having a frustum shape in sectional view is formed on the inner surface of the light shielding portion 32a.

Meanwhile, the colored layers 6R and 6G are formed on the inner surface of the upper substrate 2 at predetermined intervals. The colored layer 6R is formed to correspond to, for example, the connecting portion 10c of the pixel electrode 10a, and the colored layer 6G is formed to correspond to, for example, the connecting portion 10c of the pixel electrode 10b. An overcoat layer 18 is formed on the inner surfaces of the colored layers 6R and 6G and a portion of the inner surface of the upper substrate 2. The transparent electrodes 8 (scanning lines) are formed on the inner surface of the overcoat layer 18. Then, the element substrate 91 and the color filter substrate 92 are bonded to each other with the sealing member 3 (not shown) interposed therebetween, so that the gap between the two substrates is maintained to be uniform by the photo spacers 27.

In the liquid crystal display device 100 having the above-mentioned structure, the liquid crystal molecules 4a are vertically aligned with respect to the element substrate 91 and the color filter substrate 92 in their initial alignment states. However, as shown in FIG. 6, disclination in the alignment of the liquid crystal molecules 4a occurs around the photo spacers 27 due to inclined side walls thereof, which causes the leakage of light in the vicinities thereof. Therefore, when the leakage of light is not prevented, defects in display, such as a reduction in contrast, occur, resulting in low display quality.

In the first embodiment, the light shielding portion 32a, which is a portion of the data line 32 having a large width and a size larger than that of the photo spacer 27 in plan view, is formed at a position corresponding to the region E1 overlapping the photo spacer 27 on the lower substrate 1 (see the plan view of FIG. 5). In particular, in the first embodiment, in order to reliably prevent the leakage of light around the photo spacers 27, the size of the light shielding is set such that a distance D1 between a side 27x of the photo spacer 27 and a side 32x of the light shielding portion 32a corresponding to the side 27x is equal to or larger than 1 μm, in the plan view of FIG. 5. That is, a distance between the outer circumference and the center of the light shielding portion 32a is larger than a distance between the outer circumference and the center of the photo spacer 27 by 1 μm or more. The leakage of light occurs due to the size of the photo spacer 27, that is, the leakage of light generally occurs between the outer circumference of the photo spacer 27 and a region separated from the outer circumference of the photo spacer 27 by about 1 μm. Therefore, it is possible to prevent the leakage of light by forming the light shielding portion 32a to be larger than the photo spacer 27 by a size corresponding thereto.

The above-mentioned structure makes it possible to reliably prevent, that is, shield the leakage of light occurring around the photo spacers 27. Therefore, in the liquid crystal display device 100 according to the first embodiment, it is possible to reliably prevent a reduction in contrast, and thus to obtain a high-quality display image without color irregularity.

### Second Embodiment

In a second embodiment, island-shaped separate patterns (light shielding portions) formed of a metallic material, such as tantalum or chrome, are formed below the photo spacers in a transmissive liquid crystal display device.

Structure of Liquid Crystal Display Device

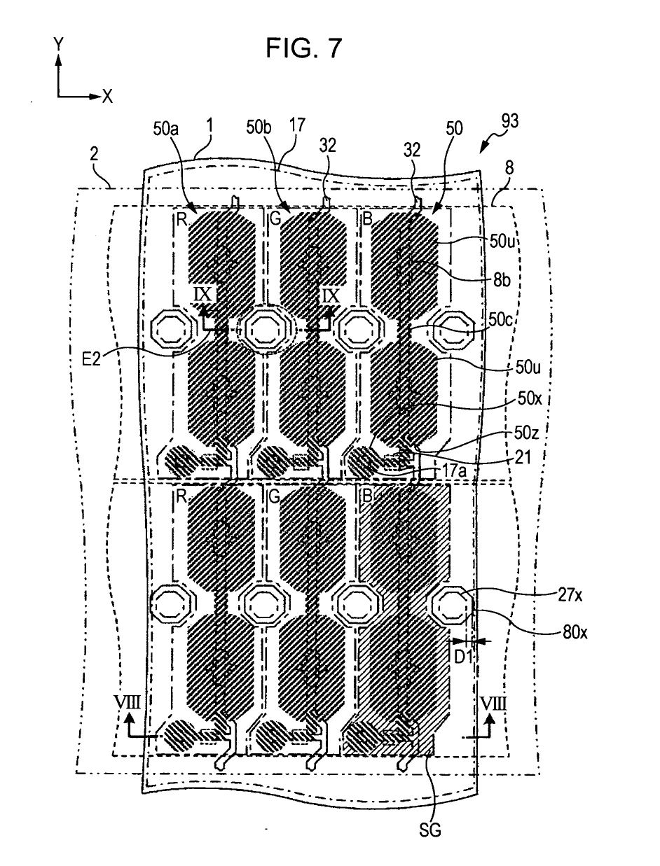

A liquid crystal display device according to the second embodiment is different from that of the first embodiment in the structure of an element substrate. Specifically, the element substrate of the second embodiment is different from that of the first embodiment in the following two aspects. First, the element substrate of the second embodiment has a so-called overlayer structure in which the pixel electrodes are isolated from the TFD elements and the data lines by an insulating film. Second, the light shielding portion, which is a portion of the data line having a large width, is not formed, but the island-shaped separate patterns, that is, light shielding portions are formed of a metallic material, such as tantalum or chrome. Therefore, the structure of the element substrate according to the second embodiment will be described below with reference to FIGS. 7 to 9. In addition, in the following description, the same components as those in the first embodiment have the same reference numerals, and a detailed description thereof will be omitted.

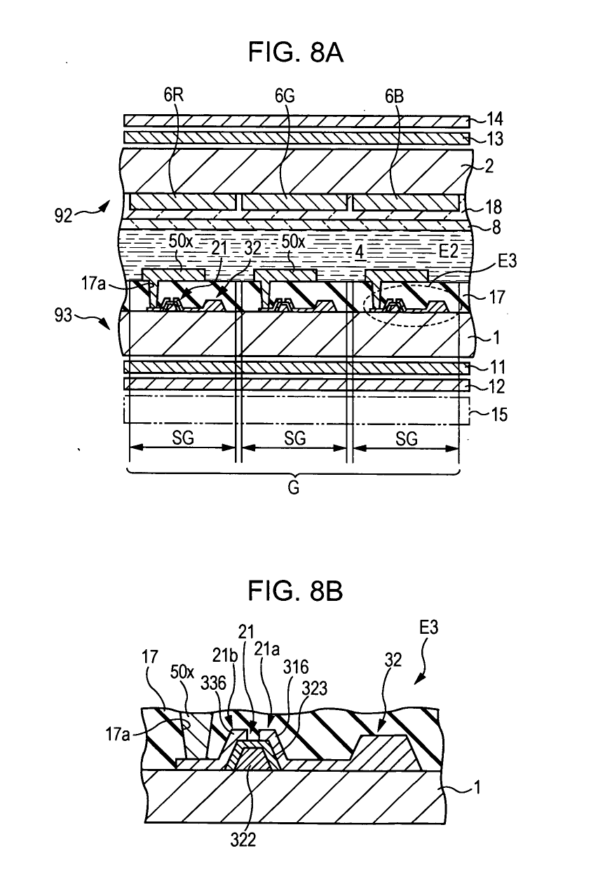

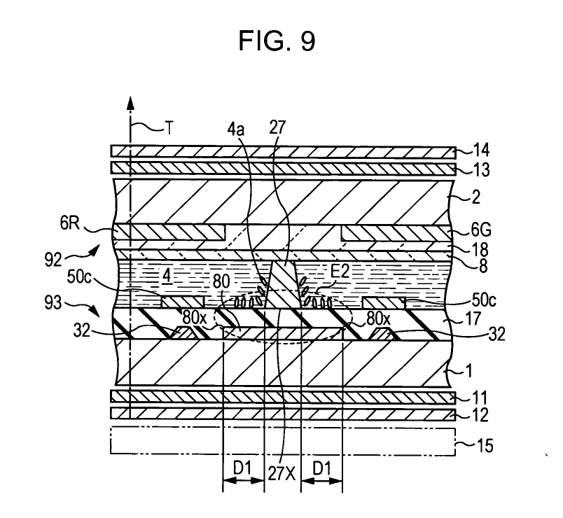

FIG. 7 is a partial plan view illustrating the layout of a plurality of pixel electrodes 50 of an element substrate 93 according to the second embodiment. FIG. 8A is a partial cross-sectional view taken along the line VIII-VIII of FIG. 7. Specifically, FIG. 8A is a cross-sectional view illustrating electrical connection between the pixel electrodes 50 and TFD elements 21 in the element substrate 93 having an overlayer structure. FIG. 8B is a partial cross-sectional view enlarging the vicinity of a region E3 shown in FIG. 8A. FIG. 9 is a cross-sectional view taken along the line IX-IX of FIG. 7.

In the plan view of FIG. 7, data lines 32 are formed in the Y direction at predetermined intervals on an inner surface of a lower substrate 1. The data line 32 is formed in the Y direction so as to pass substantially the centers of a plurality of sub-pixel regions SG in the widthwise direction, the sub-pixel regions SG being arranged in a line in the Y direction. A TFD element 21 is formed in each sub-pixel region SG on the inner surface of the lower substrate 1. Each TFD element 21 is electrically connected to the corresponding data line 32. An overlayer 17 formed of an insulating material, such as a transparent resin, is formed on the inner surfaces of the lower substrate 1, the data lines 32, and the TFD elements 21. An opening, that is, a contact hole 17a is formed at a corner of the sub-pixel region SG around the TFD element 21 in the overlayer 17. The pixel electrode 50 is formed in each sub-pixel region SG on the inner surface of the overlayer 17. The pixel electrode 50 overlaps the data line 32 in plan view, and the data line 32 is formed in the Y direction to pass substantially the center of the pixel electrode 50 in the widthwise direction.

Each pixel electrode 50 includes a plurality (two in this embodiment) of polygonal transparent electrode portions (hereinafter, referred to as ‘unit electrode portions 50u’), a first narrow connecting portion 50c, and a second connecting portion 50x. The first connecting portion 50c is formed between the unit electrode portions 50u to electrically connect them. The second electrode portion 50x extends from an outer side 50z of the unit electrode portion 50u arranged around the TFD element 21 toward the contact hole 17a. In addition, the second connecting portion 50x extending into the contact hole 17a passes through the contact hole 17a to be electrically connected to the TFD element 21, as described later.

The pixel electrode 50 having the above-mentioned structure has a dumbbell shape in plan view. For example, paying attention to a pixel electrode 50a and a pixel electrode 50b adjacent thereto, a region E2 is formed between the first connecting portions 50c of the pixel electrodes 50a and 50b. The region E2 is formed between the sub-pixel regions SG corresponding to the pixel electrodes 50a and 50b. That is, the region E2 is formed at a position separated from the unit electrode portions 50u of the pixel electrodes 50a and 50b, and a photo spacer 27 is arranged in the region E2. In addition, for the same reason as the first embodiment, the photo spacer 27 is not formed at a position corresponding to the TFD element 21.

Further, a group of pixel electrodes 50 arranged in a line in the X direction is opposite to a transparent electrode 8 (scanning line) of the upper substrate 2. Openings 8b having substantially crucial shapes in plan view are formed in the transparent electrode 8 at positions corresponding to substantially the centers of the unit electrode portions 50u constituting the pixel electrode 50. The openings 8b formed in the transparent electrode 8 make it possible to control the alignment direction of the liquid crystal molecules that are vertically aligned in an initial alignment state, similar to the first embodiment.

A light shielding portion 80 is formed on a portion of the inner surface of the lower substrate 1 corresponding to the region E2. That is, paying attention to the pixel electrodes 50a and 50b, the light shielding portion 80 is formed on a portion of the inner surface of the lower substrate 1 corresponding to the region E2 that is positioned between the first connecting portion 50c of the pixel electrode 50a and the first connecting portion 50c of the pixel electrode 50b adjacent thereto. In this case, it is preferable that the light shielding portion 80 be formed of an opaque metallic material, such as chrome or tantalum, or a black resin material. The light shielding portion 80 is formed substantially in a polygonal shape, in plan view, having a size larger than that of the photo spacer 27 in order to shield a region where the leakage of light occurs.

Next, the structure of the lower substrate 1 around the contact hole 17a for electrically connecting the pixel electrode 50 and the TFD element 21 will be described with reference to FIGS. 8A and 8B.

In FIG. 8A, the TFD elements 21 and the data lines 32 are formed on the inner surface of the lower substrate 1. The TFD element 21 is formed in each sub-pixel region SG to be electrically connected to the corresponding data line 32. The structure of the TFD element 21 will be described below with reference to FIG. 8B.

The TFD element 21 includes a first TFD element 21a and a second TFD element 21b. The first TFD element 21a and the second TFD element 21b each have a first island-shaped metal film 322 whose main ingredient is tantalum tungsten, an insulating film 323 formed by anodizing the surface of the first metal film 322, and second metal films 316 and 336 that are formed on the insulating film 323 to be separated from each other. The second metal films 316 and 336 are formed by patterning the same conductive film formed of, for example, chrome, and the second metal film 316 is branched from the data line 32 in a ‘T’ shape. The second metal film 336 is connected to the second connecting portion 50x of the pixel electrode 50.

In the first TFD element 21a of the TFD element 21, the second metal film 316, the insulating film 323, and the first metal film 322 are arranged in this order from the data line 32, and the first TFD element 21 has a laminated structure of a metal film, an insulator, and a metal film. Therefore, the first TFD element 21b has a non-linear current-voltage characteristic in both positive and negative polarities. Meanwhile, in the second TFD element 21b, the first metal film 322, the insulating film 323, and the second metal film 336 are arranged in this order from the data line 32, and the second TFD element 21 has a structure opposite to that of the first TFD 21a. Therefore, a current-voltage characteristic of the second TFD element 21b and the current-voltage characteristic of the first TFD element 21a are symmetric with respect to the origin. As a result, since the TFD element 21 is formed by connecting two TFD elements in series in the opposite direction, the non-linear current-voltage characteristics of the TFD element 21 in both the positive and negative polarities are symmetric, compared to the case in which one TFD element is used.

As shown in FIGS. 8A and 8B, the overlayer 17 having the contact hole 17a in each sub-pixel region SG is formed on the inner surfaces of the lower substrate 1, the TFD elements 21, and the data lines 32 with a predetermined thickness. The second connecting portion 50x of the pixel electrode 50 is formed in the contact hole 17a and on the inner surface of the overlayer 17 in each sub-pixel region SG. As shown in FIGS. 8A and 8B, the second connecting portion 50x is connected to the second metal film 336 of the TFD element 21 through the contact hole 17a. In this way, in the element substrate 93, the pixel electrode 50 is electrically connected to the TFD element 21 and the data line 32. In addition, the element substrate 93 has an overlayer structure in which the pixel electrodes 50 are insulated from the data lines 32 by the overlayer 17. This structure makes it possible to prevent parasitic capacitance from occurring between the pixel electrode 50 and the data line 32, and thus to prevent the generation of a so-called longitudinal cross-talk. The longitudinal cross-talk means a phenomenon in which, when a single color, such as red, blue, or green, or a complementary color to red, blue, or green, such as cyan, magenta, or yellow, is displayed in a rectangular shape on a gray background, the parasitic capacitance causes areas positioned at upper and lower sides of the rectangular display region to be displayed more brightly than the original background color, and to be displayed with a faint color. The structure of the color filter substrate 92 is the same as that of the first embodiment.

Next, the main sectional structure around the light shielding portion 80 according to the invention will be described with reference to FIG. 9. In the following description, the same components as described above have the same reference numerals, and a detailed description thereof will be omitted.

The light shielding portions 80 are formed around the regions E2 on the inner surface of the lower substrate 1. The data lines 32 are formed on the right and left sides of the light shielding portion 80 on the inner surface of the lower substrate 1 in plan view. The overlayer 17 is formed on the inner surfaces of the light shielding portion 80 and the data lines 32. The first connecting portions 50c of the pixel electrodes 50a and 50b are formed at positions overlapping the data lines 32 on the inner surface of the overlayer 17. The photo spacer 27 having substantially a frustum shape in sectional view is formed at a position overlapping the light shielding portion 80 on the inner surface of the overlayer 17. In addition, the structure of the color filter substrate 92 is the same as the sectional structure shown in FIG. 6. In this way, the gap between the element substrate 93 and the color filter substrate 92 bonded to each other with the sealing member 3 (not shown) interposed therebetween is maintained to be uniform by the photo spacers 27.

In the liquid crystal display device of the second embodiment having the above-mentioned structure, as described above, the alignment disorder of the liquid crystal molecules 4a occurs around the photo spacers 27 due to the side walls thereof. The alignment disorder causes the leakage of light around the photo spacers 27. When the leakage of light is not prevented, defects in display, such as a reduction in contrast, may occur.

In the second embodiment, the light shielding portion 80 having a size larger than that of the photo spacer 27 in plan view is formed at a position corresponding to the region E2 overlapping the photo spacer 27 on the lower substrate 1 (see the plan view of FIG. 7). In addition, in the second embodiment, in order to reliably prevent the leakage of light around the photo spacers 27, the size of the light shielding portion 80 is set such that a distance D1 between a side 27x of the photo spacer 27 and a side 80x of the light shielding portion 80 corresponding to the side 27x is equal to or larger than 1 μm in the plan view of FIG. 7, similar to the first embodiment (see the cross-sectional view of FIG. 9). In this way, in the second embodiment, it is possible to reliably prevent the leakage of light occurring around the photo spacers 27, and thus to obtain the same effects as those in the first embodiment.

Further, in the second embodiment, since the light shielding portion 80 is formed as an island-shaped separate pattern, no current/voltage is directly applied to the light shielding portion 80. Therefore, even then the light shielding portion 80 is formed of a conductive material, such as chrome or tantalum, parasitic capacitance does not occur between the light shielding portion 80 and the pixel electrode 50, which does not cause the longitudinal cross-talk.

Method of Manufacturing Liquid Crystal Display Device

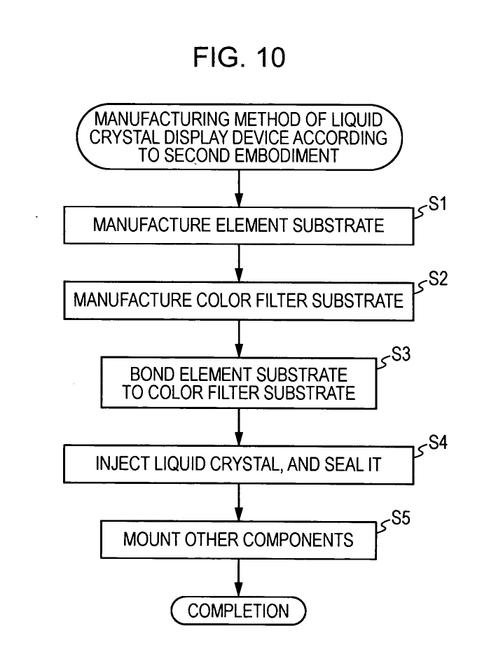

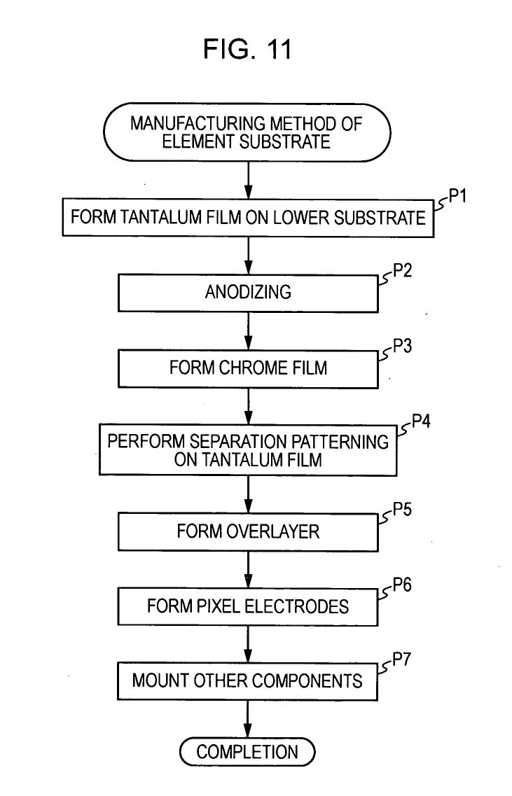

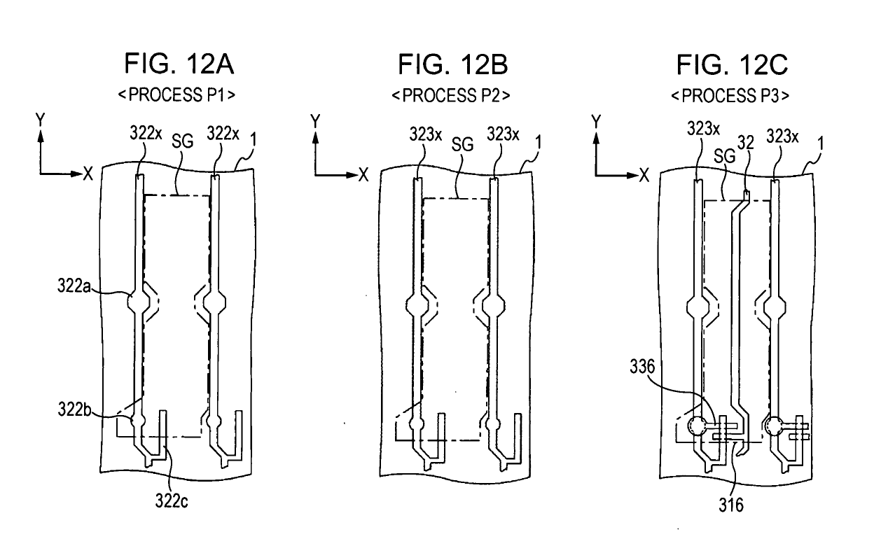

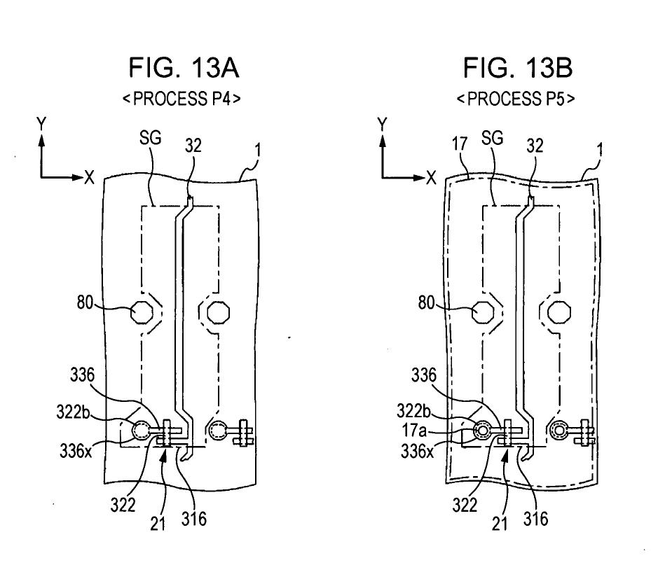

Next, a method of manufacturing the liquid crystal display device according to the second embodiment will be described with respect to FIGS. 10 to 13. FIG. 10 is a flow chart illustrating the method of manufacturing the liquid crystal display device according to the second embodiment. FIG. 11 is a flow chart illustrating step S1 shown in FIG. 10. More specifically, FIG. 11 is a flow chart illustrating a method of manufacturing the element substrate 93 when the light shielding portion 80 is formed of tantalum. FIGS. 12A to 12C and FIGS. 13A and 13B are partial plan views of the vicinity of one sub-pixel region, corresponding to processes P1 to P5 of the flow chart shown in FIG. 11. In addition, FIGS. 12A to 12C and FIGS. 13A and 13B are partial plan views illustrating the vicinity of one sub-pixel region of the element substrate 93. In FIGS. 12A to 12C and FIGS. 13A and 13B, a region surrounded by a one-dot chain line indicates one sub-pixel region SG.

First, the element substrate 93 is manufactured (step S1). The manufacturing method of the element substrate 93 will be described below with reference to FIGS. 11 to 13B. As shown in FIG. 12A, a tantalum film 322x is formed in a predetermined pattern on a portion of the lower substrate 1 corresponding to the vicinity of the edge of the sub-pixel region SG (process P1). At that time, a first polygonal region 322a is formed substantially at the center of the sub-pixel region SG in the Y direction between the sub-pixel regions SG, and a second circular region 322b is formed at a lower left corner of the sub-pixel region SG in plan view. In addition, a branch line 322c that is branched from the main line of the tantalum film 322x and extends in the Y direction is formed substantially at the center of the lower end of the sub-pixel region SG.

Then, as shown in FIG. 12B, a Ta₂O₅ film, that is, an insulting film 323x is formed on the tantalum film 322x with a predetermined thickness by an anodizing method (process P2). Subsequently, a chrome film is formed thereon (process P3). More specifically, as shown in FIG. 12C, the second metal film 336 having the shape shown in FIG. 12C is formed so as to be laid across the main line and the branch line 322c of the anodized tantalum film 322x, and the data line 32 having the shape shown in FIG. 12C is formed so as to extend in the Y direction substantially at the center of the sub-pixel region SG in the X direction (process P3). At the same time, the first metal film 316 is formed so as to be branched from the main line of the data line 32 in a ‘T’ shape.

Subsequently, patterning for separating the tantalum film is performed (process P4). More specifically, as shown in FIG. 13A, the remaining tantalum film 322x used for anodizing in the above-mentioned process is removed. In this way, the first metal film 322 having the insulating film 323 formed on the surface thereof and an island-shaped polygonal separate pattern, that is, the light shielding film 80 are formed, and the TFD element 21 including the first TFD element 21a and the second TFD element 21b is formed. At that time, the second region 322b having the anodized surface remains as an island-shaped circular pattern below a portion 336x of the second metal film 336 (corresponding to a circular portion of the second metal film 336 in FIG. 13A).

Successively, the overlayer 17 is formed (process P5). More specifically, the overlayer 17, serving as an insulating film, is formed on the lower substrate 1, the data lines 32, the TFD elements 21 with a predetermined thickness. In addition, the overlayer 17 is preferably formed of a photosensitivity and transmissive material, such as acrylic resin. At the same time, the contact hole 17a is formed on the portion 336x of the second metal film 336 by a stepper or an exposure apparatus.

Then, the pixel electrode 50 is formed (process P6). More specifically, as shown in FIGS. 7 and 8, the pixel electrode 50 including a plurality of polygonal unit electrode portions 50u is formed in the sub-pixel region SG. In this way, the second connecting portion 50x of the pixel electrode 50 is electrically connected to the second metal film 336 of the TFD element 21 at the contact hole 17a. That is, the pixel electrode 50 is electrically connected to the data line 32 through the TFD element 21.

Subsequently, the other components are mounted (process P7). More specifically, as shown in FIGS. 8A and 8B, for example, a retardation plate (quarter-wave plate) 11, a polarizing plate 12, and a backlight 15 are provided at the lower side of the lower substrate 1. In this way, the element substrate 93 shown in FIGS. 7 to 9 is manufactured.

Referring to FIG. 10 again, in the next process, the color filter substrate shown in FIGS. 8A and 8B and FIG. 9 is manufactured by a well-known method (step S2), and the element substrate 93 and the color filter substrate 92 are bonded to each other with the sealing member 3 (not shown) interposed therebetween (step S3). Then, liquid crystal having negative dielectric anisotropy is injected into a space between the element substrate 93 and the color filter substrate 92 through an opening (not shown) formed therebetween, and then the opening is sealed (step S4). Subsequently, the other components are mounted to manufacture the liquid crystal display device shown in FIGS. 8A and 8B and FIG. 9. The liquid crystal display device manufactured in this way can have the same effects as described above.

According to the above-mentioned manufacturing method of the liquid crystal display device according to the second embodiment, in the process of manufacturing the anodized tantalum film, that is, the first metal film 322, the light shielding portion 80 is formed of the same material as the tantalum film. Therefore, the number of processes for forming the light shielding portion 80 is reduced, which makes it possible to simplify a manufacturing process. In addition, in the liquid crystal display device manufactured in this manner, the second region 322b having the anodized surface remains as a circular pattern below the portion 336x of the second metal film 336 corresponding to the position of the contact hole 17a. However, since the second region 322b is formed as an island-shaped separate pattern, the second region 322b does not have an electrical influence on the pixel electrode 50, the TFD element 21, and the data line 32.

### Third Embodiment

In a third embodiment, island-shaped separate patterns (light shielding portions) formed of a metallic material, such as tantalum or chrome, are formed below photo spacers in a transflective liquid crystal display device, similar to the second embodiment, which makes it possible to obtain the same effects as those in the second embodiment.

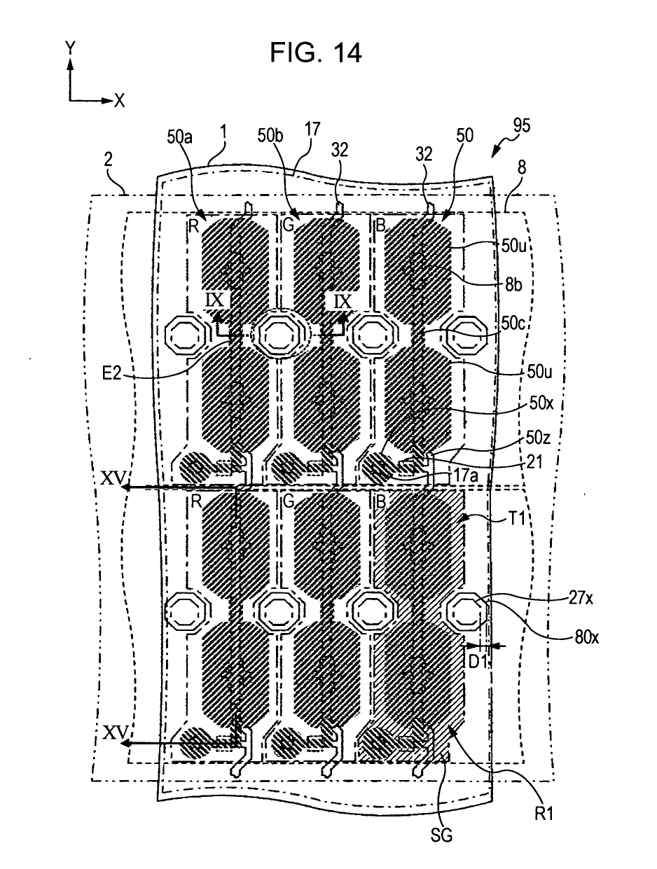

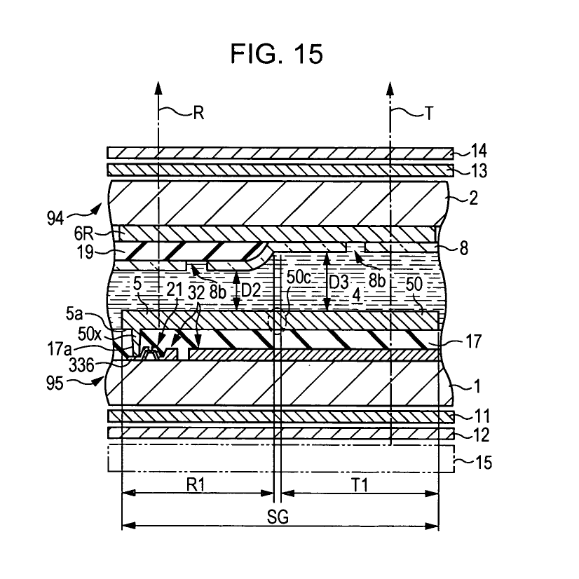

The third embodiment is different from the second embodiment in that the transflective liquid crystal display device is used in the third embodiment, and the transmissive liquid crystal display device is used in the second embodiment. The size and positional relationship between the light shielding portion 80 and the photo spacer 27 in the third embodiment are the same as those in the second embodiment. Therefore, the structure of an element substrate according to the third embodiment will be described below with reference to the partial cross-sectional view of FIG. 9 and FIGS. 14 and 15. In addition, in the third embodiment, the same components as those in the second embodiment have the same reference numerals, and a detailed description thereof will be omitted. FIG. 14 is a partial plan view illustrating the layout of a plurality of pixel electrodes 50 of an element substrate 95 according to the third embodiment. FIG. 15 is a partial plan view taken along the line XV-XV of FIG. 14. A partial plan view taken along the line IX-IX of FIG. 14 is substantially similar to the partial plan view (that is, the partial plan view of FIG. 9) taken along the line IX-IX of FIG. 7 according to the second embodiment.

As can be understood from a comparison between the partial plan view of the element substrate 95 according to the third embodiment and the partial plan view of the element substrate 93 according to the second embodiment respectively shown in FIGS. 14 and 7, the structure of the element substrate 95 is substantially the same as that of the element substrate 93. However, the third embodiment is different from the second embodiment in that a reflective film is formed below a unit electrode portion 50 positioned in the vicinity of a TFD element 21 in one sub-pixel region SG.

Next, the sectional structure corresponding to the vicinity of one pixel electrode 50 will be described below with reference to FIG. 15.

First, the structure of the element substrate 95 will be described. In FIG. 15, data lines 32 are formed on an inner surface of a lower substrate 1, and the TFD element 21 is formed in each sub-pixel region SG on the inner surface of the lower substrate 1. The data line 32 is electrically connected to the TFD element 21. An overlayer 17 is formed with a predetermined thickness on the inner surfaces of the lower substrate 1, the data lines 32, and the TFD elements 21. The overlayer 17 has contact holes 17a each arranged at a position corresponding to a portion of a second metal film 336 of the TFD element 21. As shown in FIG. 15, each sub-pixel region SG includes a reflective display region R1 for performing reflective display and a transmissive display region T1 for performing transmissive display, and a reflective film 5 formed of a metallic material, such as aluminum, is formed on the inner surface of the overlayer 17 to correspond to the reflective display region R1. In addition, in the plan view of FIG. 14, the reflective film 5 is formed below only a second connecting portion 50x and unit electrode portions 50u connected to each other by the second connecting portion 50x in each sub-pixel region SG. Further, as shown in FIG. 15, the reflective film 5 has an opening 5a at a position corresponding to the contact hole 17a.

The pixel electrode 50 having, for example, a plurality of unit electrode portions 50u is formed in each pixel region SG, that is, on the inner surface of the reflective film 5 corresponding to the reflective display region R1 and the inner surface of the overlayer 17 corresponding to the transmissive display region T1. The second connecting portion 50xof each pixel electrode 50 is connected to the second metal film 336 of the TFD element 21 through the contact hole 17a. A vertical alignment film (not shown) is formed on the inner surfaces of the pixel electrodes 50.

Next, the structure of a color filter substrate 94 will be described. In FIG. 15, a colored layer 6R is formed on the inner surface of the upper substrate 2. An insulating film 19 having unevenness on the surface thereof is formed with a predetermined thickness on the inner surface of the colored layer 6R corresponding to the reflective display region R1. Transparent electrodes 8 (scanning lines) are formed on the inner surface of the insulating film 19 corresponding to the reflective display region R1 and on the inner surface of the colored layer 6R corresponding to the transmissive display region T1. Openings 8b having substantially crucial shapes in plan view are formed in the transparent electrode 8 at positions corresponding to the unit electrode portions 50u in the reflective display region R1 and the transmissive display region T1. The openings 8b make it possible to control the alignment directions of the liquid crystal molecules that are vertically aligned in an initial alignment state. A vertical alignment film (not shown) is formed on the inner surfaces of the transparent electrodes 8. Liquid crystal having negative dielectric anisotropy is injected between the element substrate 95 and the color filter substrate 94 in a state in which the two substrates are bonded to each other with the sealing member 3 (not shown) interposed therebetween.

In the liquid crystal display device of the third embodiment having the above-mentioned structure, the photo spacers 27 (not shown) and the insulating film 19 formed to correspond to the reflective display regions R1 on the color filter layer 94 cause the thicknesses of a liquid crystal layer 4 to be different from each other in the reflective display region R1 and the transmissive display region T1. That is, the liquid crystal display device has a so-called multi-gap structure in which the thickness of the liquid crystal layer 4 corresponding to the reflective display region R1 is set to D2, and the thickness of the liquid crystal layer 4 corresponding to the transmissive display region T1 is set to D3 (>D2). Therefore, the liquid crystal display device can perform proper display in both transmissive display and reflective display.

When reflective display is performed in the liquid crystal display device, external light incident on the liquid crystal display device travels along a path R shown in FIG. 15, and passes through the region where the colored layer 6 is formed. Then, the light is reflected from the reflective film 5 positioned below the colored layer 6, and passes through the colored layer 6 again to be emitted to a display screen. In this way, a displayed image having a predetermined color and brightness is viewed by an observer. On the other hand, when transmissive display is performed in the liquid crystal display device, illumination light emitted from the backlight 15 travels along a path T shown in FIG. 15, and then passes through the pixel electrode 50 and the colored layer 6 to reach the observer. In this case, the illumination light passes through the colored layer 6 to have a predetermined color and brightness. In this way, a desired color display image is viewed by the observer.

In the liquid crystal display device of the third embodiment having the above-mentioned structure, similar to the second embodiment, the island-shaped light shielding portion 80 having a size larger than that of the photo spacer 27 in plan view is formed at a position corresponding to the region E2 overlapping the photo spacer 27 on the lower substrate 1 (see the plan view of FIG. 14 and the cross-sectional view of FIG. 9 corresponding to the sectional line IX-IX of FIG. 14). Therefore, in the third embodiment, it is possible to reliably prevent the leakage of light occurring around the photo spacers 27, and thus to obtain the same effects as those in the second embodiment. In addition, in the third embodiment, the other effects are the same as those in the second embodiment.

Modifications

In the first to third embodiments, the openings 8a and 8b are formed in the transparent electrode 8 (scanning line) of the color filter substrate at positions corresponding to substantially the centers of the unit electrode portions 10u and 50u, respectively. However, the invention is not limited to these structures. That is, convex projections may be formed on the transparent electrode 8 (scanning line), instead of the openings. In addition, the projections can be formed of, for example, resin. This structure also makes it possible to control the liquid crystal molecules to be radially aligned in the unit electrode portions 10u or 50u.

Further, in the first to third embodiments, the unit electrode portion 10u or 50u is formed substantially in a polygonal shape, but the invention is not limited thereto. The unit electrode portion 10u or 50u may be formed substantially in a circular shape.

Furthermore, in the first to third embodiments, the photo spacer 27 and the light shielding portions 32a and 80 are formed in polygonal shapes in plan view, but the invention is not limited thereto. The photo spacer 27 and the light shielding portions 32a and 80 may be formed in various shapes. However, in this case, it is necessary that the light shielding portion 32a or 80 be formed such that the size thereof is larger than that of the photo spacer 27 in plan view, more preferably, such that a distance between the outer circumference of the light shielding portion 32a or 80 and the center thereof is larger than a distance between the outer circumference of the photo spacer 27 and the center thereof by 1 μm or more.

Moreover, in the manufacturing method of the liquid crystal display device according to the second embodiment, the light shielding portion 80 is formed of, for example, a tantalum film, but the invention is not limited thereto. The light shielding portion 80 may be formed of chrome. In this case, in the process P3 of the flow chart shown in FIG. 11, that is, in the process of forming the chrome film, the light shielding portion 80 is simultaneously formed with, for example, the data line 32. As a result, the number of processes for forming the light shielding portion 80 is reduced, which makes it possible to simplify a manufacturing process. In addition, the material forming the light shielding portion 80 is not limited to a conductive material, but the light shielding portion 80 may be formed of a material other than tantalum and chrome, such as resin. In this case, it is necessary to increase the number of processes for forming the light shielding portion 80. However, since the light shielding portion 80 is formed of a non-conductive material, such as resin, the light shielding portion 80 does not have an electrical influence on peripheral components thereof.

Further, in the above-mentioned embodiments, the pixel electrodes are arranged in a strip shape, but the invention is not limited thereto. The pixel electrodes may be arranged in a delta array. In this case, for example, in FIGS. 5, 7, and 14, the pixel electrodes and the connecting portions in two sub-pixel regions adjacent to each other in the Y direction shift in the X direction. Therefore, the connecting portion of one pixel electrode is aligned with the other pixel electrode in the pixel region adjacent to the one pixel electrode in the Y direction, not with the connecting portion of the other pixel electrode. Thus, the light shielding portion is formed between a pixel electrode and a connecting portion of another pixel electrode adjacent to the pixel electrode, not between the connecting portions of the pixel electrodes adjacent to each other in the Y direction. This structure is also included in the scope of the invention.

Furthermore, in the above-mentioned embodiments, the liquid crystal display device has the TFD elements as switching elements, but the invention is not limited thereto. The invention can be applied to a liquid crystal display device having TFT elements as the switching elements.

Electronic Apparatus

Next, an embodiment in which the liquid crystal display device 100 according to the first embodiment of the invention is used as a display unit of an electronic apparatus will be described. In addition, the liquid crystal display devices according to the second and third embodiments can also be applied to the display unit of the electronic apparatus.

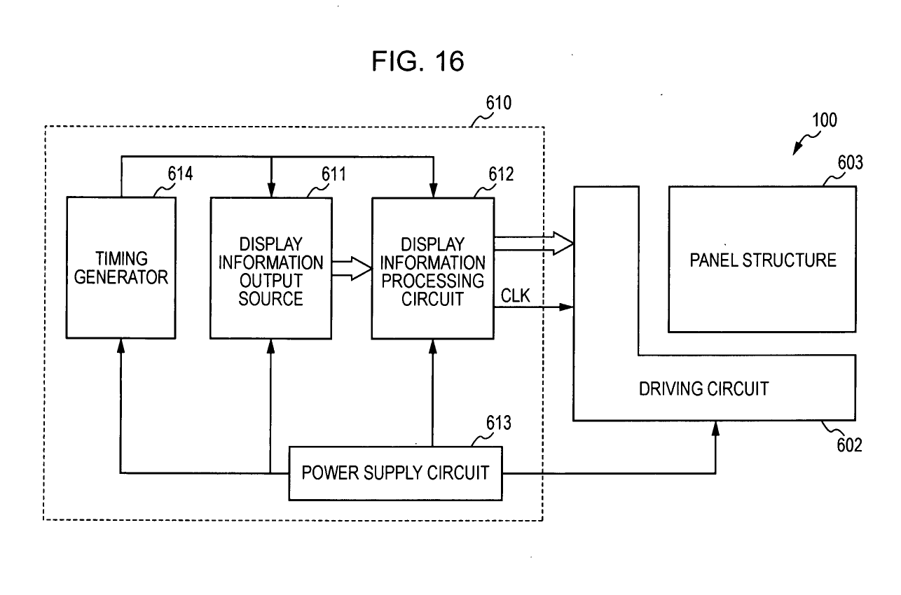

FIG. 16 is a block diagram schematically illustrating the overall structure of this embodiment. The electronic apparatus shown in FIG. 16 includes the liquid crystal display device 100 and a control unit 410 for controlling the liquid crystal display device 100. In FIG. 16, the liquid crystal display device 100 is conceptually divided into a panel structure 403 and a driving circuit 402 composed of, for example semiconductor ICs. In addition, the control unit 410 includes a display information output source 411, a display information processing circuit 412, a power supply circuit 413, and a timing generator 414.

The display information output source 411 has a memory composed of a ROM (read only memory) or a RAM (random access memory), a storage unit composed of, for example, a magnetic recording disk or an optical recording disk, and a tuning circuit for tuning and outputting digital image signals. The display information output source 411 supplies display information to the display information processing circuit 412 in the form of image signals having a predetermined format, on the basis of various clock signals generated by the timing generator 414.

The display information processing circuit 412 includes various well-known circuits, such as a serial-parallel conversion circuit, an amplification/inversion circuit, a rotation circuit, a gamma correction circuit, and a clamp circuit. The display information processing circuit 412 processes input display information to supply the processed image information to the driving circuit 402 together with a clock signal CLK. The driving circuit 402 includes a scanning line driving circuit, a data line driving circuit, and a test circuit. In addition, the power supply circuit 413 supplies a predetermined voltage to the above-mentioned components.

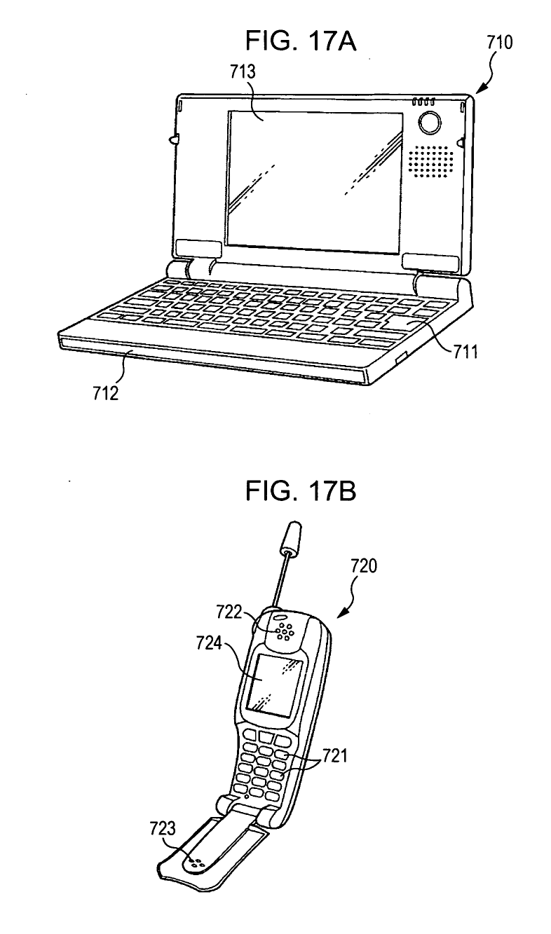

Next, examples of the electronic apparatus to which the liquid crystal display device 100 according to the first embodiment of the invention is applicable will be described with reference to FIGS. 17A and 17B.

First, an example in which the liquid crystal display device 100 according to the first embodiment is applied to a display unit of a portable personal computer (a so-called notebook computer) will be described. FIG. 17A is a perspective view illustrating the structure of the personal computer. As shown in FIG. 17A, a personal computer 710 includes a main body 712 having a keyboard 711 and a display unit 713 to which the liquid crystal panel according to the invention is applied.

Subsequently, another example in which the liquid crystal display device 100 according to the first embodiment is applied to a display unit of a cellular phone will be described. FIG. 17B is a perspective view illustrating the structure of the cellular phone. As shown in FIG. 17B, a cellular phone 720 includes a plurality of operating buttons 721, an earpiece 722, a mouthpiece 723, and a display unit 724 to which the liquid crystal display device 100 of the invention is applied.

Further, the liquid crystal display device 100 of the invention can be applied to a liquid crystal television, a view-finder-type/monitor-direct-view-type videotape recorder, a car navigation apparatus, a pager, an electronic organizer, an electronic calculator, a word processor, a workstation, a television phone, a POS terminal, and a digital still camera, in addition to the personal computer shown in FIG. 17A and the cellular phone shown in FIG. 17B.

What is claimed is:

1. A liquid crystal device comprising:
a first substrate;
a second substrate that is bonded to the first substrate;
pillar-shaped spacers interposed between the first and second substrates; and
a liquid crystal layer that is provided between the first substrate and the second substrate,
the first substrate including:
pixel electrodes each having a plurality of unit electrode portions and connecting portions that connect the unit electrode portions;
switching elements that are connected to the pixel electrodes; and
wiring lines that are arranged between adjacent pixel electrodes to be connected to the switching elements, each wiring line including a light shielding portion disposed between the connecting portion of one pixel electrode and the connecting portion of an adjacent pixel electrode, each light shielding portion overlapping a corresponding spacer and being larger than that of the spacer.

2. The liquid crystal device according to claim 1,
wherein the light shielding portion is formed between the connecting portion of one pixel electrode and the connecting portion of another pixel electrode positioned in the vicinity of the connecting portion.

3. A liquid crystal device comprising:
a first substrate;
a second substrate that is bonded to the first substrate with pillar-shaped spacers interposed therebetween; and
a liquid crystal layer that is provided between the first substrate and the second substrate,
the first substrate including:
light shielding portions;
wiring lines;
switching elements that are connected to the wiring lines;
an insulating film that has contact holes each formed at a position corresponding to a portion of the switching element and covers the light shielding portions, the wiring lines, and the switching elements; and
pixel electrodes each of which includes a plurality of unit electrode portions and connecting portions for connecting the unit electrode portions, and which are formed on the insulating film to be connected to the switching elements through the contact holes,
wherein each light shielding portion has a size larger than that of the spacer, and is formed between the connecting portion of one pixel electrode and another pixel electrode adjacent thereto, and
the spacer is arranged on the insulating film to overlap the light shielding portion.

4. A liquid crystal device comprising:
a first substrate;
a second substrate that is bonded to the first substrate with pillar-shaped spacers interposed therebetween; and
a liquid crystal layer that is provided between the first substrate and the second substrate,
the first substrate including:
light shielding portions;
wiring lines;
switching elements that are connected to the wiring lines;
an insulating film that has contact holes each formed at a position corresponding to a portion of the switching element and covers the light shielding portions, the wiring lines, and the switching elements;
a reflective film that is formed in a portion of an pixel region on the insulating film; and
pixel electrodes each of which includes a plurality of unit electrode portions, a first connecting portion for connecting the unit electrode portions, and a second connecting portion that extends from one outer side of the unit electrode portion to the contact hole to be connected to the switching element through the contact hole, and is formed on the reflective film and the insulating film in each pixel region,
wherein each light shielding portion has a size larger than that of the spacer, and is formed between the first connecting portion of one pixel electrode and another pixel electrode adjacent thereto, and
the spacer is arranged on the insulating film to overlap the light shielding portion.

5. The liquid crystal device according to claim 3,
wherein the light shielding portion is formed between the connecting portion of the one pixel electrode and the connecting portion of another pixel electrode positioned in the vicinity of the connecting portion.

6. The liquid crystal device according to claim 3,
wherein the wiring lines and the light shielding portions are formed of the same material.

7. The liquid crystal device according to claim 4,
wherein the reflective film is formed at a position corresponding to at least one unit electrode portion.

8. The liquid crystal device according to claim 4,
wherein the second substrate includes:
a colored layer that is formed at positions corresponding to the pixel regions;
an insulating film that is formed with a predetermined thickness on the colored layer to correspond to at least the reflective film; and
strip-shaped transparent electrodes that are formed on the colored layer and the insulating film.

9. The liquid crystal device according to claim 3,
wherein the wiring lines are formed to overlap the pixel electrodes, and
the light shielding portion is formed between the wiring lines adjacent to each other.

10. The liquid crystal device according to claim 1,
wherein the unit electrode portion and the light shielding portion are formed in a shape in which a distance between the outer circumference and the center thereof is equal.

11. The liquid crystal device according to claim 10,
wherein the unit electrode portion and the light shielding portion are formed in substantially polygonal or circular shapes.

12. The liquid crystal device according to claim 1,
wherein a distance between a side of the light shielding portion and a side of the spacer corresponding thereto is set to be equal to or larger than 1 μm.

13. The liquid crystal device according to claim 1,
wherein the light shielding portions are formed of tantalum, chrome, or black resin.

14. The liquid crystal device according to claim 1,
wherein the second substrate is provided with openings or projections formed at positions corresponding to substantially the centers of the unit electrode portions.

15. The liquid crystal device according to claim 1,
wherein the liquid crystal layer has negative dielectric anisotropy.

16. An electronic apparatus comprising the liquid crystal device according to claim 1 as a display unit.
